(19) United States
(12) Patent Application Publication
(10) Pub. No.: US 2005/0209887 A1
(43) Pub. Date: Sep. 22, 2005

(54) Method and system for providing a portable diary and display of fitness information

(76) Inventor: Richard Pollner, Warren, NJ (US)

Correspondence Address: Diane Dunn McKay, Esq.;Mathews, Collins, Shepherd & McKay, P.A., Suite 306, 100 Thanet Circle, Princeton, NJ, 08540, US

(21) Appl. No.: 10/975,559

(22) Filed: Oct. 28, 2004

Related U.S. Application Data
(60) Provisional application No. 60/554,240, filed on Mar. 18, 2004.

(51) Int. Cl. G06F 17/60

(52) U.S. Cl. 705/3

(57) ABSTRACT

The present invention relates to a method and system for providing a diary for fitness information. In one embodiment, the system is used to enter information and access information directed to one or more of workouts, meals, strength training, reports, body composition results, fitness results, triathlete information, race information, pace information, runners' information, and coach information. The system includes a handheld device, such as a personal digital assistant (PDA). The handheld device can be combined with a remote processing system and video player. For example, the remote processing system can include an Internet connection and personal computer (PC). The handheld device can download a custom workout. The user can upload a completed workout from the handheld device to the remote processing system. The user can enter fitness tests and run reports from the remote processing system. Videos, animations or graphics can be viewed at the handheld device demonstrating proper technique for each exercise.

### CROSS REFERENCE TO RELATED APPLICATION

This application claims the benefit of U.S. Provisional Patent Application No. 60/554,240, filed Mar. 18, 2004, the entirety of which is hereby incorporated by reference into this application.

### BACKGROUND OF THE INVENTION

1. Field of the Invention

The present invention relates generally to a portable system for storing and monitoring fitness information and more specifically, to a portable personal training device to provide a diary for fitness information and fitness testing which can also include video or graphics for demonstrating proper techniques of exercises or skills to be performed and can be networked to a remote computing device.

2. Description of Related Art

Devices for monitoring diet and activity are known. U.S. Pat. No. 6,153,532 describes a diet and activity-monitoring device for monitoring consumption and activity of the subject. A body activity monitor monitors the body activity of a subject. By calibrating the body activity monitor, the subject's activity level and activity related expenditure may be determined. The monitoring device includes a consumption notation control for use by the subject to indicate when the subject consumes food.

U.S. Pat. No. 6,571,200 describes an apparatus for monitoring the caloric expenditure rate of a subject. A caloric expenditure rate detector detects and measures the caloric expenditure rate of a subject. A body activity detector concurrently measures body activity to enable subsequently detected body activity measurements to be converted to the caloric expenditure rate of the respective subject.

U.S. Pat. No. 6,702,719 describes a method for controlling an exercise machine in which an exercise machine receives exercise-related data for a particular user via an independent computing device specified by the user, such as a portable computer system, personal storage device or network system. The computer system may include a schedule of exercise machines for the user to utilize. The computer system may also include fitness goals such as the number of calories the user wants to burn or the number of repetitions at a particular weight that the user needs to perform on a strength training apparatus.

It is desirable to provide a portable personal training device which can provide ready access to fitness information such as workouts and fitness tests and can also provide video demonstrations or graphics of fitness information.

### SUMMARY OF THE INVENTION

The present invention relates to a method and system for providing a diary for fitness information. In one embodiment, the system is used to enter information and access information directed to one or more of workouts, meals, strength training, reports, body composition results, fitness results, triathlete information, race information, pace information, runners' information, and coach information. The system includes a handheld device, such as a personal digital assistant (PDA). The handheld device can be combined with a remote processing system and video player. For example, the remote processing system can include an Internet connection and personal computer (PC). The handheld device can download a custom workout. The user can upload a completed workout from the handheld device to the remote processing system. The user can enter fitness tests and run reports from the remote processing system. Videos, animations or graphics can be viewed at the handheld device demonstrating proper technique for each exercise.

The method and system can be used, for example, to create a custom workout for a client, provide a strength training diary or provide a runner/triathlete diary. In one embodiment, a strength training diary application can be used to keep track of workouts and enter workouts by either a user or a trainer. An embodiment of an online strength training diary allows the user and trainer to keep track of workouts at a location that is easily accessible to both. In an alternate embodiment, a runner's diary allows a user and coach to keep track of workouts in a location that is easily accessible to both. Accordingly, coaches can view the runner's progress remotely, allowing easier evaluation of the training plan.

Custom workouts can be entered as easy as a few clicks of the mouse. Videos of individual techniques can be displayed at the handheld device to help build a desirable workout for a client. Once the workout is entered at a PC or website, it can be saved, for example, as an Excel or Palm file. The file can then be downloaded to the handheld device.

The use of a strength training diary on a handheld device, such as a personal digital assistant (PDA), allows a trainer to toss all those loose papers of handwritten workouts and replace them with an electronic version, easily assessable on the personal digital assistant (PDA). The strength training diary also keeps track of the client's workout as executed including technique, equipment, repetitions, sets and weight. The strength training diary can include tools for the trainer such as a KG/pound conversion and 1 repetition max calculator. Clients' custom workouts can be stored on the personal digital assistant (PDA) before going to the gym and completed workouts can then be saved on the personal digital assistant (PDA) and later uploaded to the strength training diary on a website in one touch of a button.

The invention will be more fully described by reference to the following drawings.

### BRIEF DESCRIPTION OF THE DRAWINGS

FIG. 1 is a schematic diagram of system for providing a portable diary and display.

FIG. 2 is a schematic diagram of an embodiment of a personal storage device.

FIG. 3 is a schematic diagram of a login screen for logging onto a strength training diary application.

FIG. 4 is a schematic diagram of an example strength training diary home page.

FIG. 5 is a schematic diagram of add to food log menu.

FIG. 6 is a schematic diagram of master list of techniques menu.

FIG. 7 is a schematic diagram of a menu of clients and client information for clients of the trainers or coaches.

FIG. 8 is a schematic diagram of a workout report of a client.

FIG. 9 is a schematic diagram of a workout report by date range.

FIG. 10 is a schematic diagram of a body composition test results report.

FIG. 11 is a schematic diagram of an example three minute step test report.

FIG. 12 is a schematic diagram of a login screen for logging onto a runner's diary application.

FIG. 13 is a schematic diagram of a runner's diary home page.

FIG. 14 is a schematic diagram of a menu for add workout race.

FIG. 15 is a schematic diagram of a delete workout menu.

FIG. 16 is a schematic diagram of a food log menu.

FIG. 17 is a schematic diagram of a report of workouts.

FIG. 18 is a schematic diagram of a report of all workouts entered for a specified date range.

FIG. 19 is a schematic diagram of a report of information directed to a chronological list of entered races.

FIG. 20 is a schematic diagram of a report of information directed to a list of entered races arranged by distance.

FIG. 21 is a schematic diagram of a report of all entered meals for the user.

FIG. 22 is a schematic diagram of report of clients and client information.

FIG. 23 is a schematic diagram of a menu for entering client and password information.

FIG. 24 is a schematic diagram of a menu for accessing custom workouts and fitness results.

FIG. 25 is a schematic diagram of software application interface screen for entry of results of a 3-minute step test.

FIG. 26 is a schematic diagram of software application interface screen for entry of body compositions test results.

FIG. 27 is a schematic diagram of software application interface screen for entry of custom workout information.

FIG. 28 is a schematic diagram of a screen on a handheld device for strength training diary application.

FIG. 29 is a schematic diagram of an example icon for interacting with a software player.

FIG. 30 is a schematic diagram of an example opened dropdown menu listing body parts for a workout.

FIG. 31 is a schematic diagram of a screen including a displayed list of techniques displayed in a corresponding techniques box and displayed list of equipment displayed in an equipment box.

FIG. 32 is a schematic diagram of a screen including display of a recommended body position.

FIG. 33 is a schematic diagram of a screen including a menu bar.

FIG. 34 is a schematic diagram of a user selection screen.

FIG. 35A is a schematic diagram of a screen for displaying and entering workout information.

FIG. 35B is a schematic diagram of a screen for displaying a database selection screen.

FIG. 35C is a schematic diagram of a screen for displaying a database deletion screen.

FIG. 35D is a schematic diagram of a screen for displaying a beam screen.

FIG. 36 is a schematic diagram of a screen including a menu for tools for designing custom workouts.

FIG. 37 is a schematic diagram of a screen for a kilogram/pound conversion calculator.

FIG. 38 is a schematic diagram of a screen for a one repetition maximum calculator.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

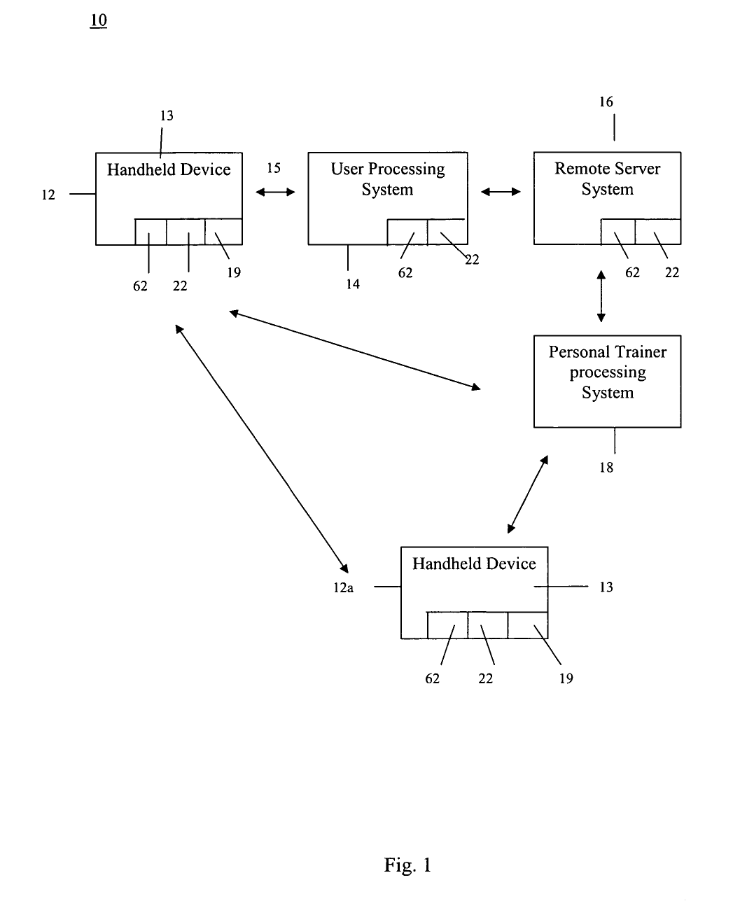

FIG. 1 is a schematic diagram of system 10 for providing a portable diary and display of fitness information. System 10 is used to enter and display fitness information into a diary of fitness information directed to one or more of workouts, food consumption, strength training, reports, body composition results, fitness results, triathlete information, race information, pace information, runner information, and coach information. The diary of fitness information is in electronic form. Handheld device 12 includes display screen 13 for entering and displaying fitness information. Display screen 13 can be a touch screen. Handheld device 12 is portable and can be taken to a location for performing fitness, such as a weight training facility, gym, pool or on a run. For example, handheld device 12 can be a personal digital assistant (PDA) including, for example, Palm based PDAs, Windows CE and Pocket PC or other PDA-like hardware platforms, such as for example, Blackberry or a cell phone. A suitable configuration for a personal digital assistant (PDA) can include a USB based HotSync Cradle, at least 8 MB of RAM, Palm OS 4.x (or later) and Palm Desktop 4.1 (or later). Handheld device 12 can also have the capability to display video, animations or graphics as described below. For video applications handheld device 12 can have at least 32 MB of RAM, or at least 64 MB of RAM, a color, high quality display and a software player. For example, a Kinoma Player can be used as a software player.

Handheld device 12 can connect to user processing system 14. User processing system 14 can be a personal computer (PC) or laptop computer directly electronically connected to or wirelessly connected to handheld device 12. Data 15 can include text, digital video, graphics, animations, audio, and other conventional forms of data which are known in the art. Handheld device 12 communicates with user processing system 14 including cable, WIFI, DSL, dial-up modem, CD-Rom, DVD, floppy disc, flashcard, memory stick or other methods known in the art for data delivery.

Software for communication with handheld device 12 can be installed on user processing system 14. For example, Palm desktop software can be installed on user processing system 14 for communication with a Palm PDA. User processing system 14 can have an Internet connection to remote server system 16. For example, remote server system 16 can be a personal computer (PC) with one of the following operating systems: Windows 2000, Windows 2003, Windows NT 4.0 (with Service Pack 6a), Windows XP, or the like. Remote server system 16 can host or communicate with website 17 for system 10 which website includes diary and fitness applications, as described below. Remote server system 16 can be a personal computer or server with one of the following operating systems: Windows 2000, Windows 2003, Windows NT 4.0 (with Service Pack 6a), Windows XP, or the like. User processing system 14 can have an Internet connection and include a login on website 17. User processing system 14 can download workouts entered on user processing system 14 or at website 17 to a diary application displayed on handheld device 12, as described below.

Personal trainer processing system 18 can connect to remote server system 16 and/or handheld device 12. Personal trainer processing system 18 can be used for personal trainers or coaches to enter fitness tests and create custom workouts for their clients. A suitable Personal trainer processing system 18 can include a personal computer (PC) with 80 MB of available hard disk space, an Internet connection, one of the following operating systems: Windows 2000, Windows 2003, Windows NT 4.0 (with Service Pack 6a), Windows XP or the like, software for communicating with website 17 for system 10 including diary and fitness applications, data entry programs, such as Excel, and software for communicating with handheld device 12.

Reports can be viewed from user processing system 14, personal trainer processing system 18 or a PC connected to the Internet for access to website 17. In order to view reports, the personal computer (PC) can include a connection to the Internet and a browser, such as, for example, Netscape or Internet Explorer.

Software 19 for installing and using system 10 can be installed on handheld device 12. For example, software 19 can comprise a plurality of files that end in .prc and .prb. The .prc files are software and the .prb files are personal digital assistant (PDA) databases, graphics and videos. Software files as well as video viewer files can be downloaded onto handheld device 12. In one embodiment, a Palm Quick Install program can be used for installing personal digital assistant (PDA) software and personal digital assistant (PDA) databases and videos. Strength training diary application 22 and runner's diary application 62 can be installed and accessed on handheld device 12.

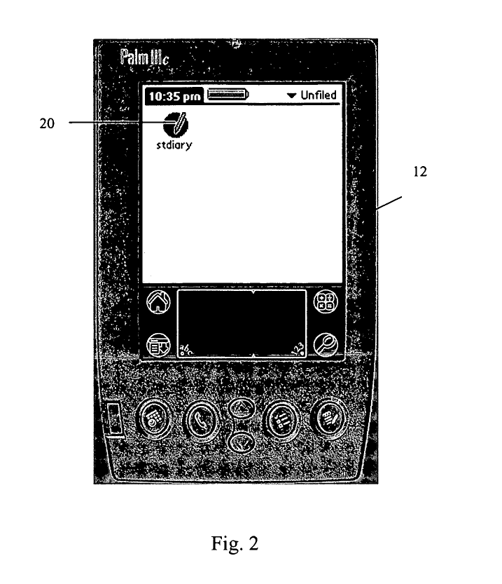

During installation, handheld device 12, such as a personal digital assistant (PDA), can be synched with a personal digital assistant (PDA) cradle. FIG. 2 illustrates an example handheld device 12 after completion of installation of software 19 for system 10. Icon 20 can be used to access strength training diary application 22 on handheld device 12. Strength training diary application 22 can be used to keep track of workouts and enter a workout by either a client or a trainer. Strength training diary application 22 at user processing system 14 or remote server system 16 can access a strength training diary. For example, a strength training diary hosted at website 17 can be accessed at website 17 by logging onto strength training diary application 22.

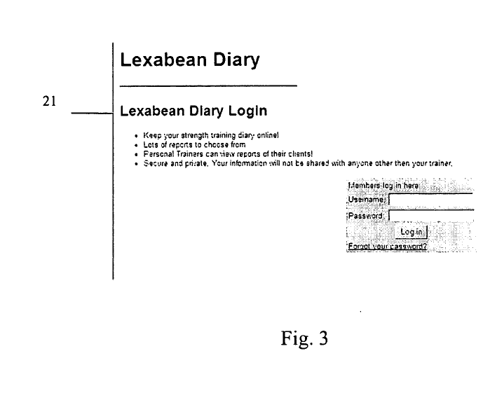

An example, login screen 21 for logging onto strength training diary application 22 is shown in FIG. 3. After logging onto strength training diary application 22, strength training diary application 22 provides a strength training diary home page.

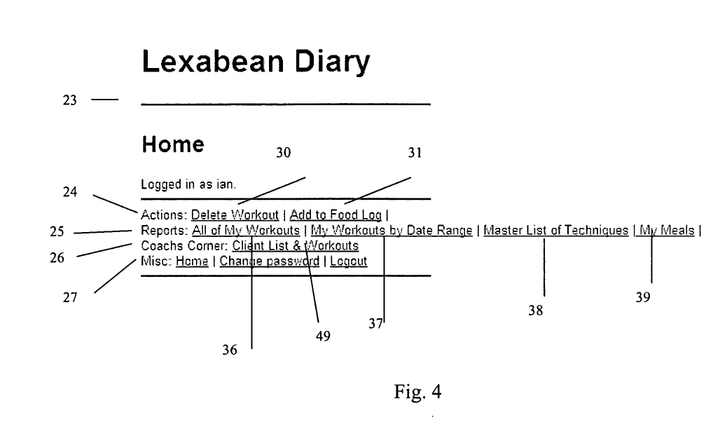

An example strength training diary home page 23 is shown in FIG. 4. Example entries for strength training diary home page 23 can include action entries 24, report entries 25, trainer or coaches interaction entries 26, and miscellaneous entries 27. Example action entries 24 can include delete workout action link 30 and add to food log action link 31. Delete workout action link 30 can be used to delete a workout entry. Upon activating delete workout action link 30 a dropdown menu can be displayed for listing potential workouts to be deleted. A workout to be deleted can be highlighted and submit request button can be clicked for submitting a request to delete the highlighted workout entry.

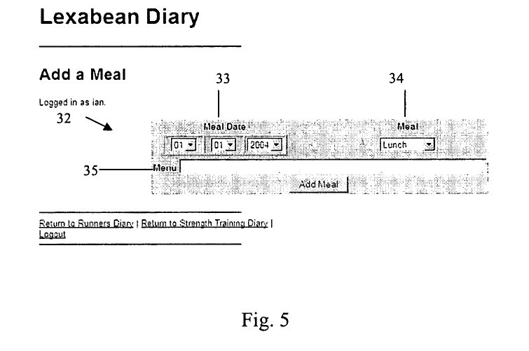

Add to food log action link 31 can be used to keep track of daily meals. For example dropdown menus can be accessed by food log action link 31 and displayed for listing date and meal information. An example add to food log menu 32 is shown in FIG. 5. Select date entry 33 can be used to enter date information. Meal type entry 34 can be used to enter the type of meal, such as breakfast, lunch, dinner or snack. Menu entry 35 can be used to enter details on the type and amount of food consumed.

Referring to FIG. 4, example report entries 25 can include all of my workouts link 36, my workouts by date range link 37, master list of techniques link 38 and my meals link 39. All of my workouts link 36 can list completed one or more workouts which have been downloaded from handheld device 12 to user processing system 14, remote server system 16 or personal trainer processing system 18. The reports list workouts for the user. My workouts by date range link 37 can list all workouts for a specified date range. My meals link 39 can list all entered meals for the user.

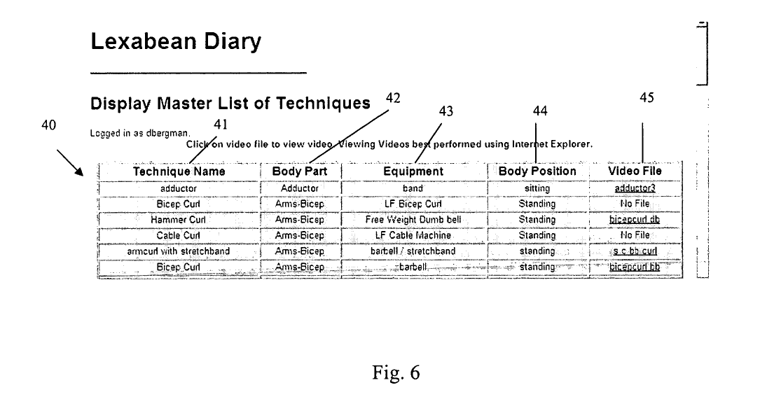

FIG. 6 is an example report 40 accessed by master list of techniques link 38. Column 41 includes entries of types of techniques. Column 42 includes entries of a body part associated with the technique of an associated entry in column 41. Column 43 includes entries of equipment for performing the technique of an associated entry in column 41. Column 44 includes entries of body position for performing the technique of an associated entry in column 41. Column 45 provides links for linking to associated videos related to the technique of an associated entry in column 41.

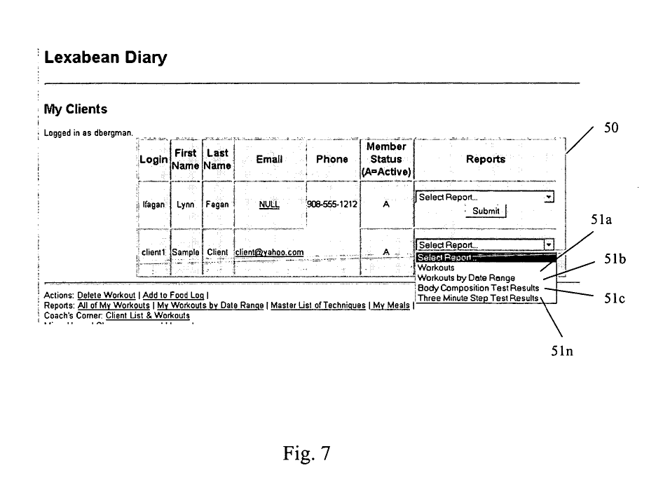

Referring to FIG. 4, trainer or coaches interaction entries 26 can be used to provide trainers or coaches with access to their own workouts as well as the workouts of their clients. Client list and workout link 49 can be used to provide a list of all clients of the trainer or coach and client information. FIG. 7 is an example menu of clients and client information for clients of the trainers or coaches 50 accessed by client list and workout link 49. Reports of client's workouts and fitness tests corresponding to the client are available by using a dropdown menu items 51a-51n. Example dropdown item entries can include workouts, workouts by date range, body composition test results and three minute step test results. It will be appreciated that other reports of workouts and fitness tests having various entries can be generated and accessed by dropdown menu items.

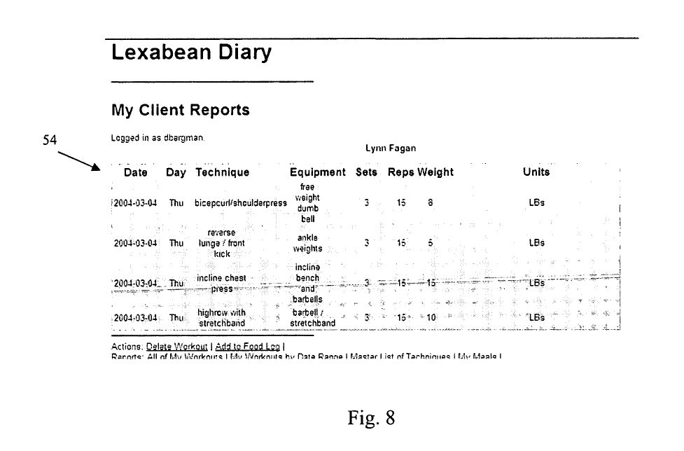

Upon selecting a report entry listed in item 51a, a report can be generated listing workouts for a selected client in chronological order. An example workout report for a client 54 is shown in FIG. 8. Workout report for a client 54 can include entries for date, day, technique, equipment, number of sets, number of repetitions amount of weight and units of weight. Workout report for a client 54 can list a plurality of reports associated with a date in chronological order.

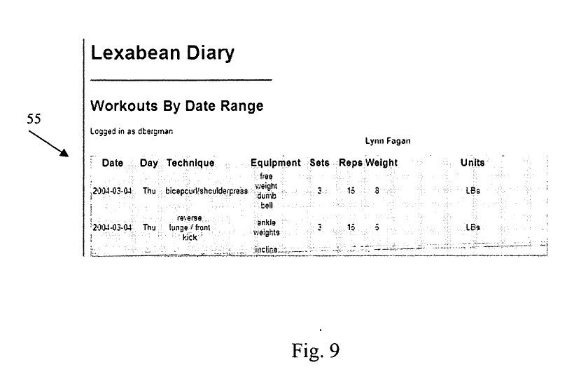

Referring to FIG. 7, upon selecting a report entry listed in item 51b, an example workout by date range report 55 can be displayed as shown in FIG. 9. Workout by date range report 55 can include entries for date, day, technique, equipment, number of sets, number of repetitions amount of weight and units of weight. Workout by date range report 55 lists workouts for a specified date range.

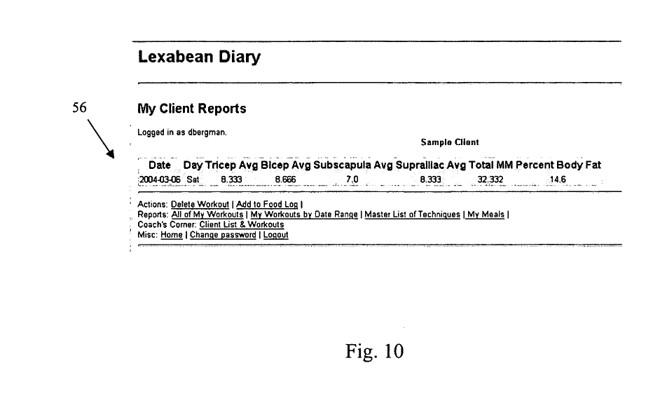

Referring to FIG. 7, upon selecting a report entry listed in item 51c, an example body composition test results report 56 can be displayed as shown in FIG. 10. Body composition and test results report 56 can include results of tricep average, bicep average, subscapula average, suprailiac average, average of the total and a percent of body fat. For example, body composition test results report 56 can list results in chronological order.

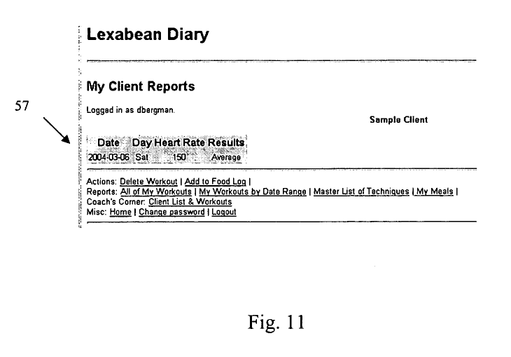

Referring to FIG. 7, upon selecting a report entry listed in item 51c, an example three minute step test report 57 can be displayed as shown in FIG. 11. Test results from a three minute step test can include heart rate and a result value.

Referring to FIG. 1, runner's diary application 62 at user processing system 14 or remote server system 16 can access a runner's diary. Runner's diary application 62 can be used by a client, such as a runner or triathlete, or coach to keep track of workouts and enter workouts. For example, a runner's diary can be accessed at website 17 for system 10 by logging onto runner's diary application 62.

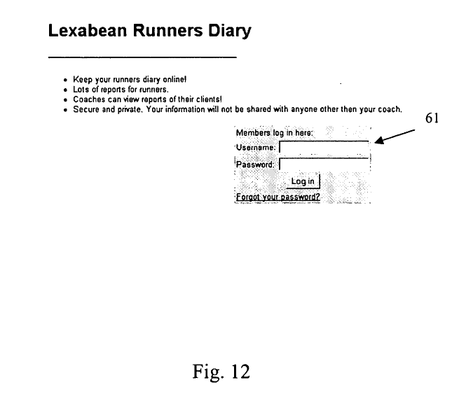

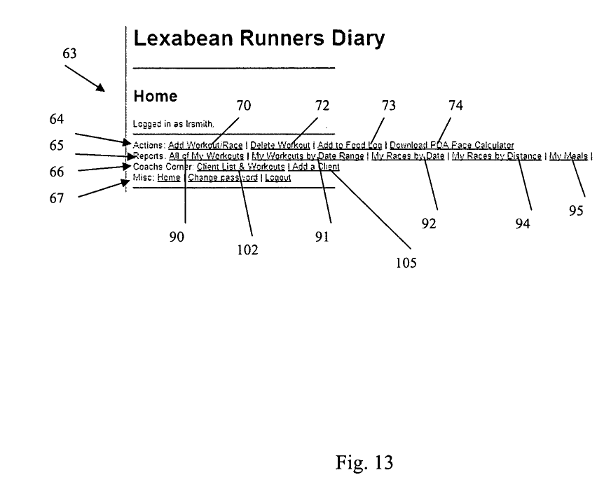

An example, login screen 61 for logging onto runner's diary application 62, is shown in FIG. 12. After logging onto runner's diary application 62, runner's diary application 62 provides a runner's diary home page. An example runner's diary home page 63 is shown in FIG. 13. Example entries for runner's diary home page 63 can include action entries 64, report entries 65, trainer or coaches interaction entries 66, and miscellaneous entries 67. Example action entries 64 can include add workout race link 70, delete workout action link 72, add to food log action link 73 and download pace calculator link 74.

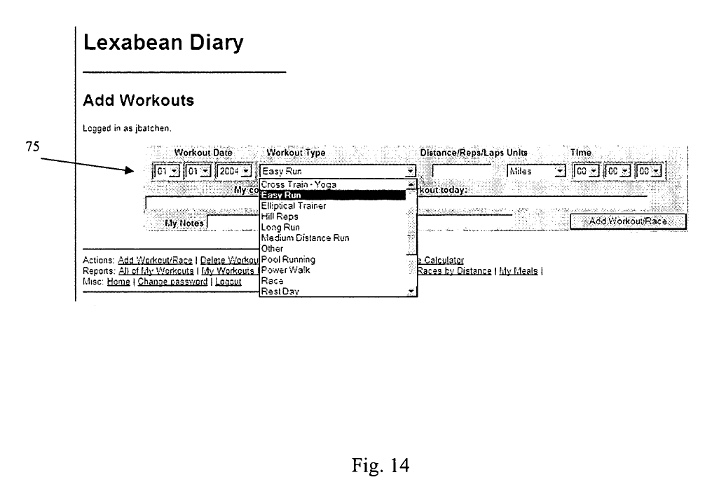

An example add workout menu 75 accessed by add workout race link 70 is shown in FIG. 14. Add workout menu 75 can use dropdown menus to add workouts and races to runner's diary application 62. Example menu items include a workout date, workout type, distance/reps/laps, units and time. The workout type can include, for example, run types, cross training, walking, pool, running, rest day and other forms of training.

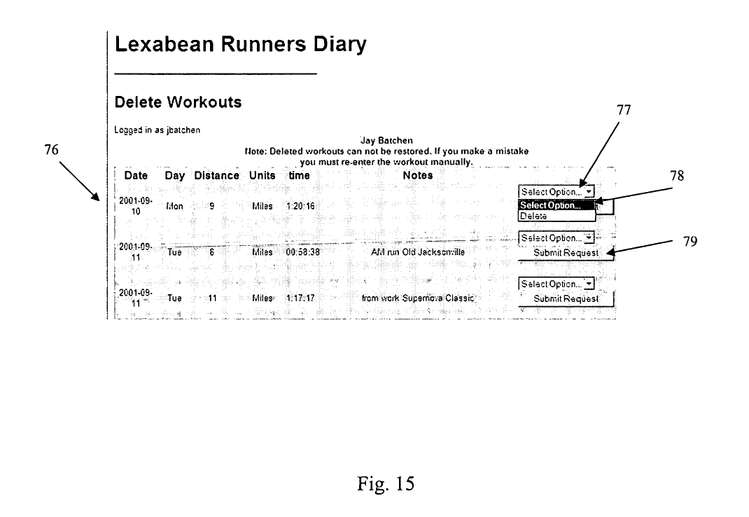

Referring to FIG. 13, delete workout action link 72 can be used to delete a workout entry. An example delete workout menu 76 is shown in FIG. 15. Upon activating delete workout action link 72 dropdown menu 77 can be displayed for selecting workouts to be deleted. A workout to be deleted can be selected with menu item 78 to highlight workout entries to be deleted. Submit request button 79 can be clicked for submitting a request to delete the highlighted workout entry.

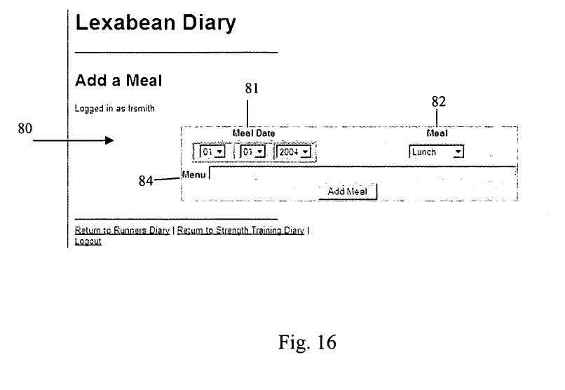

Referring to FIG. 13, add to food log action link 73 can be used to keep track of daily meals. For example dropdown menus can be displayed for listing date and meal information. An example food log menu 80 is shown in FIG. 16. Select date entry 81 can be used to enter date information. Meal type entry 82 can be used to enter the type of meal, such as breakfast, lunch, dinner or snack. Menu entry 84 can be used to enter details on the type and amount of food consumed.

Referring to FIG. 13, download pace calculator link 74 can be used to download a pace calculator, such as a Palm Pace Calculator, to handheld device 12.

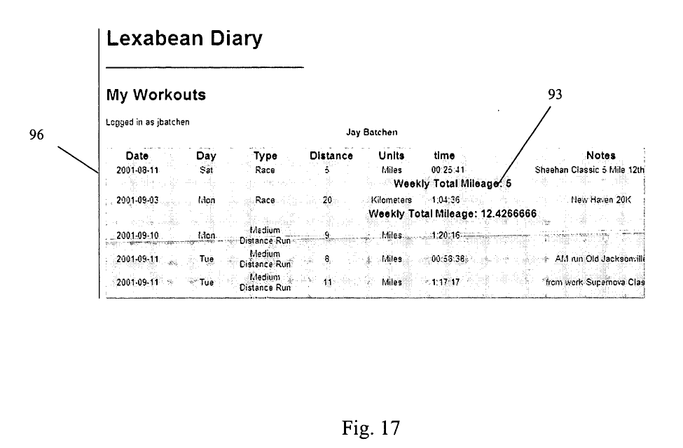

Example report entries 65 can include all of my workouts link 90, my workouts by date range link 91, my races by date link 92, my races by distance link 94 and my meals link 95. All of my workouts link 90 can list a report of completed workouts which have been uploaded from handheld device 12. FIG. 17 is an example workout report 96 of workouts from all of my workouts link 90. Workout report 96 lists workouts for the user. The workouts can include entries for date, day, type, distance, units and time. Workout report 96 can include weekly mileage entry 93 for displaying the weekly mileage completed during workouts for the user. The workouts can be listed chronologically.

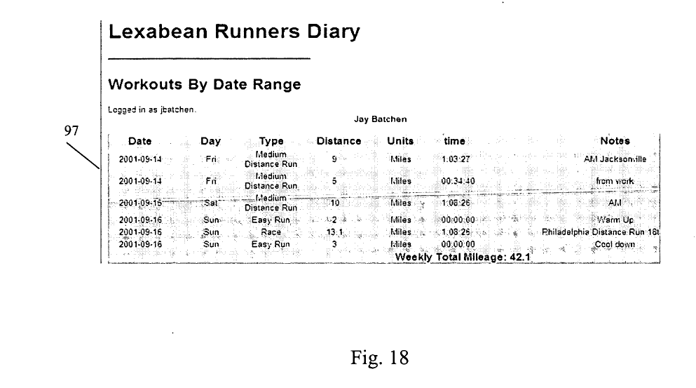

Referring to FIG. 13, my workouts by date range link 91 can access a report of all workouts entered for a specified date range. FIG. 18 is an example of workout report by date range 97 providing a listing of workouts for a specified date range having entries such as date, day, type, distance, units and time.

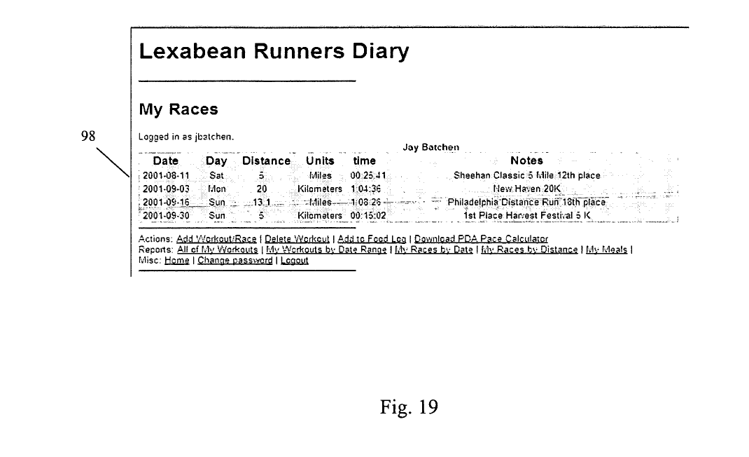

Referring to FIG. 13, my races by date link 92 can access a report of information directed to a chronological list of entered races. FIG. 19 is an example race report 98 of races accessed by activating my races by date link 92.

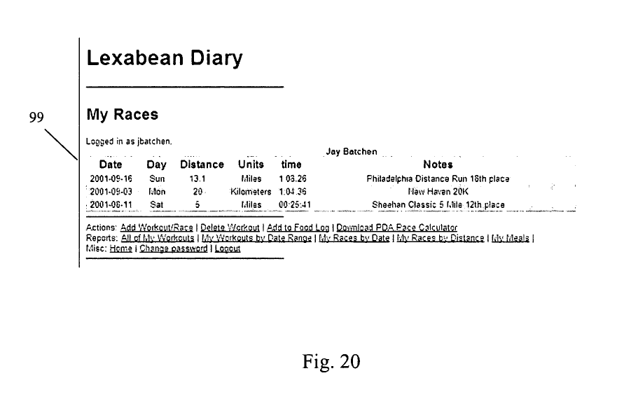

Referring to FIG. 13, my races by distance link 94 can list a report of information directed to a list of entered races arranged by distance. For example, the list of races can be arranged in a longest to shortest format. FIG. 20 is an example race by distance report 99 of races accessed by my races by distance link 94. Example entries for race report 98 and race by distance report 99 include date, distance, units, time and notes.

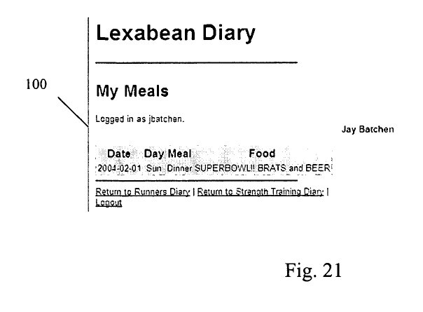

Referring to FIG. 13, my meals link 95 can list a report of all entered meals for the user. FIG. 21 is an example meals report 100 of an entered meal accessed by my meals link 95.

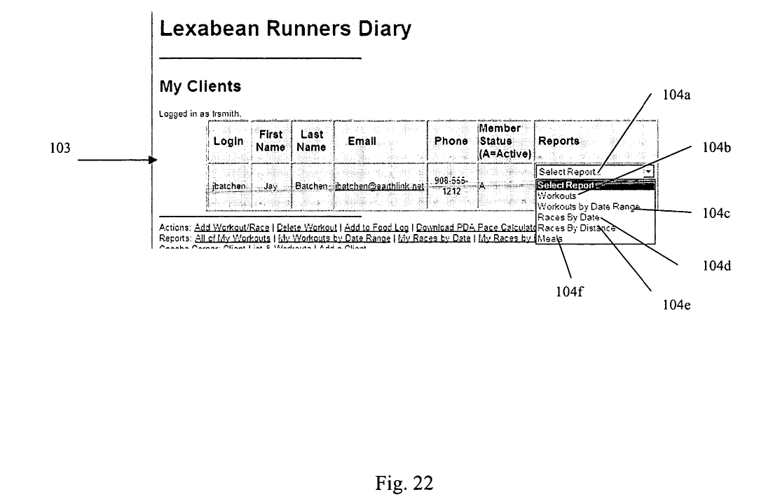

Trainer or coaches' interaction entries 66 can optionally be used to provide trainers or coaches with access to their own workouts as well as the workouts of their clients. Client list and workout link 102 can be used to provide a list of all clients of the trainer or coach. FIG. 22 is an example report 103 of clients and client information accessed by client list and workout link 102. Reports of clients' workouts are available by using a dropdown menu items 104a-104n corresponding to the client. Example dropdown item entries include reports 104a, workouts 104b, workouts by date 104c, races by date 104d, races by distance 104e and meals 104n.

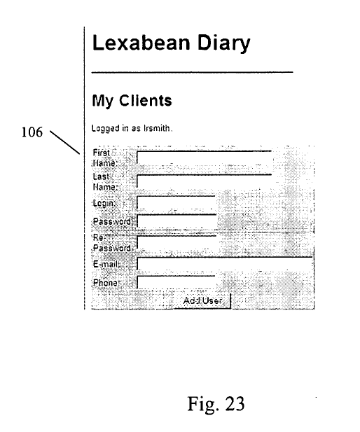

Referring to FIG. 13, add a client link 105 can be used to add clients to be associated with client list and workout link 102. An example menu for entering client and password information 106 is shown in FIG. 23.

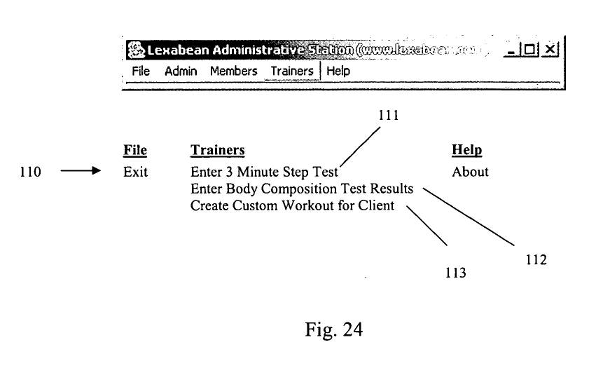

Referring to FIG. 1, custom workouts and fitness results can be entered at user processing system 14, remote server system 16 or personal trainer processing system 18. For example, user processing system 14 can be used at home or at a user station in a gym. An example menu 110 for accessing custom workouts and fitness results is shown in FIG. 24. Enter 3-minute step test link 111 provides a link to a software application for entering the results of the standard YMCA 3-minute step test.

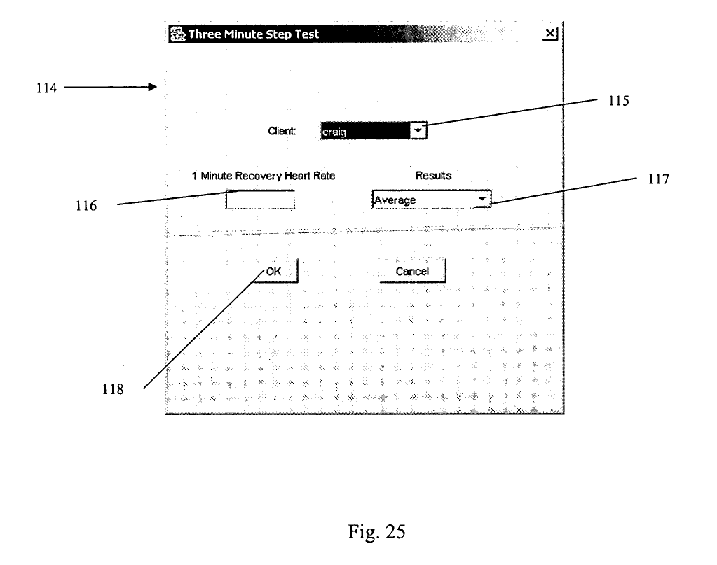

An example interface generated by a software application for entry of results of a 3-minute step test using dialog box 114 is shown in FIG. 25. A client's name can be selected using client dropdown menu box 115. Data can be entered into 1-minute recovery heart rate box 116. An accessed result can be selected from results dropdown menu 117. For example, using a client's recovery heart rate, the personal trainer can enter an assessed result (Average, Above Average, Good, and the like) obtained from consulting tables of norms specific to gender and age. After entering the data into heart rate box 116 and results dropdown menu 117, OK button 118 can be clicked. The results of the test can be saved to website 17 for system 10, user personal system 14 or trainer processing system 18. The results can be viewed using strength training diary application 22 at website 17 or at user processing system 14 or at personal trainer processing system 18. The test and results obtained can be repeated and each of the results can be displayed. Accordingly, an assessment of a user or client progress over time can be performed.

Referring to FIG. 24, enter body composition link 112 provides a link to a software application for entering body composition test results. For example, a conventional skin fold caliper test can be used to measure a client's ratio of fat tissue to lean body mass. In one embodiment, a plurality of measurements can be entered for each of the tricep, bicep, subscapula and suprailiac.

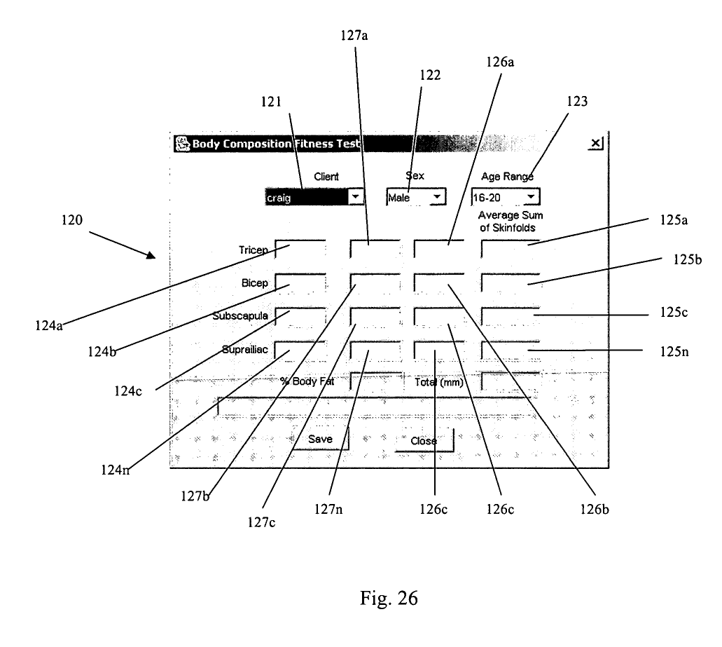

An example software application interface screen for entry of body composition test results using dialog box 120 is shown in FIG. 26. A client's name can be selected using client dropdown menu box 121. Sex information can be entered in sex information box 122. Age information can be entered in age range box 123. Data related to type of measurements from a skin fold caliper test can be entered into respective boxes 124a-124n. For example, a minimum of two and a maximum of three caliper measurements in mm units can be entered. An average value of each row of skin fold values can be calculated and displaced in respective boxes 125a-125n. A total mm value based on the sum of the averages can be calculated and displaced in respective boxes 126a-126n. A percentage (%) body fat value based on the total mm value and client's gender/age can be calculated and displayed in respective boxes 127a-127n. The results of the tests, such as total mm and % body fat, test date and client's ID can be saved to website 17 for system 10 and can be viewed using strength training diary application 22 at website 17, user processing system 14 or personal trainer processing system 18. Each of the results can be displayed. Accordingly, an assessment of the progress over time can be performed.

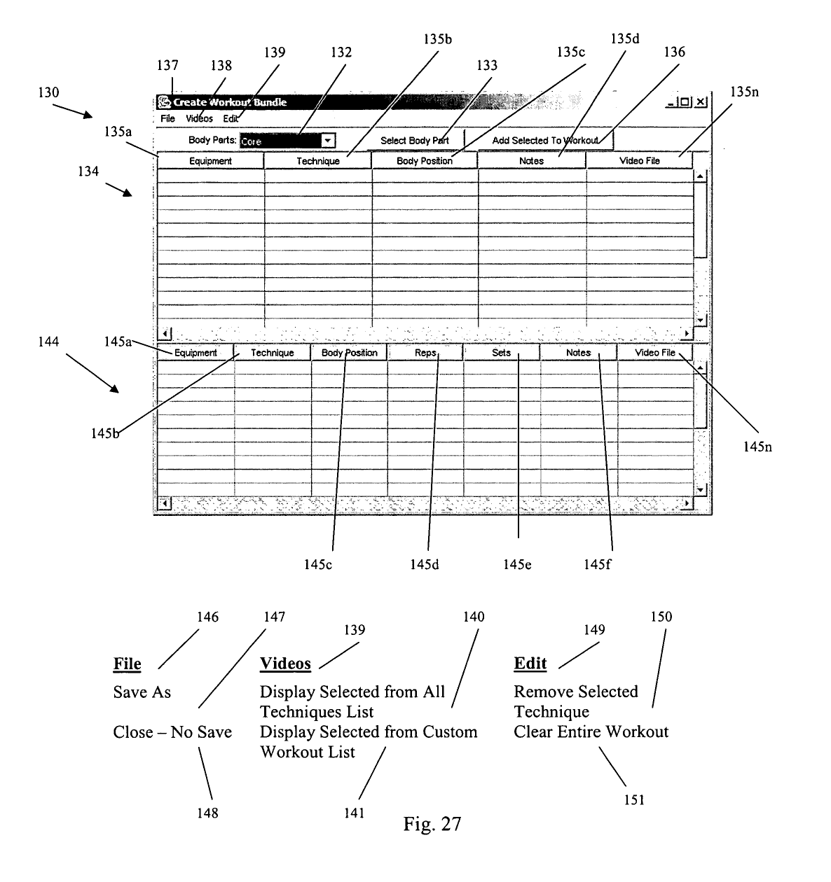

Referring to FIG. 24, create custom workout for client link 113 provides a link to a software application for creating custom workouts. An example software application interface screen 130 for entry of custom workout information is shown in FIG. 27.

A body part can be selected from body parts dropdown menu 132. Upon selecting a body part, select body part button 133 can be clicked. Thereafter, table 134 including columns 135a-135n can be updated with techniques available for the selected body part, including equipment, body position and optionally a video file of the technique.

Techniques can be selected using a mouse to click on a row of the listed techniques. Videos can be displayed by clicking button 138 to display video menu 139. Menu item display selected from all techniques list 140 can be selected to view the video. After entering items in columns 135a-135n, add selected to workout button 136 can be selected and the items entered in corresponding column 135a, 135b, 135c, 135d and 135n will appear in table 144 in respective columns 145a, 145b, 145c, 145f and 145n. A plurality of techniques can be selected or entered in table 134 to determine a custom workout and all selected techniques will appear in table 144.

After customizing a workout, video can be displayed using menu item display selected from custom workout list 141. A determined number of repetitions of techniques to be performed can be entered in column 145d. A determined number of sets can be entered in column 145c.

Upon finishing the custom workout, file button 137 can be pressed to display file menu 146. Menu item save 147 can be selected to save the created workout of table 144. For example, the file can be saved in an Excel format or a PDA format. The saved created custom workout from table 144 can be downloaded to handheld device 12. Menu item close no save 148 can be selected to close the create custom workout software application without saving the selected information.

Edit button 139 can be pressed to display edit menu 149. Menu item remove selected technique 150 can be selected to remove selected techniques and corresponding information in columns 145a-145n from table 144. Menu item clear entire workout 151 can be selected to delete all entries from table 144.

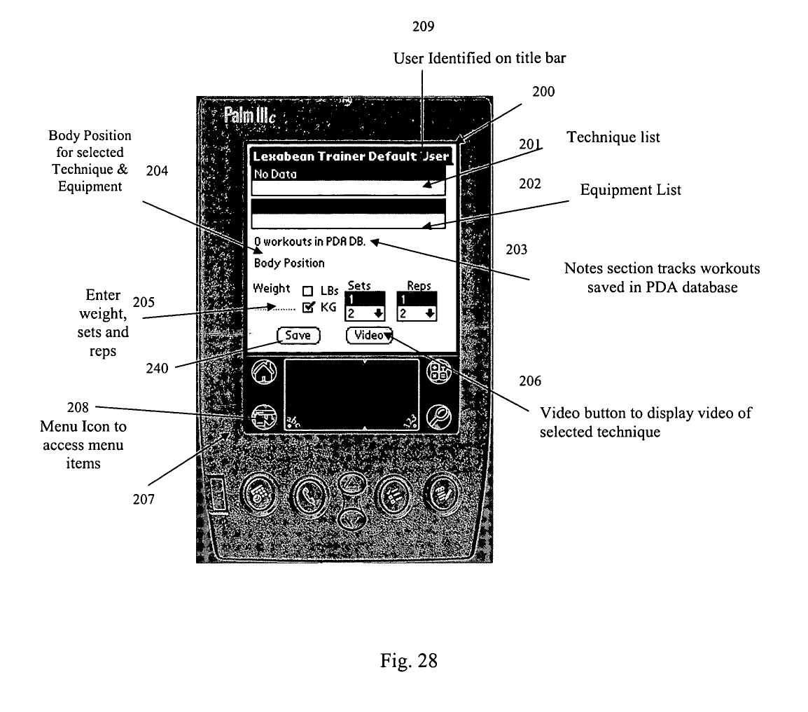

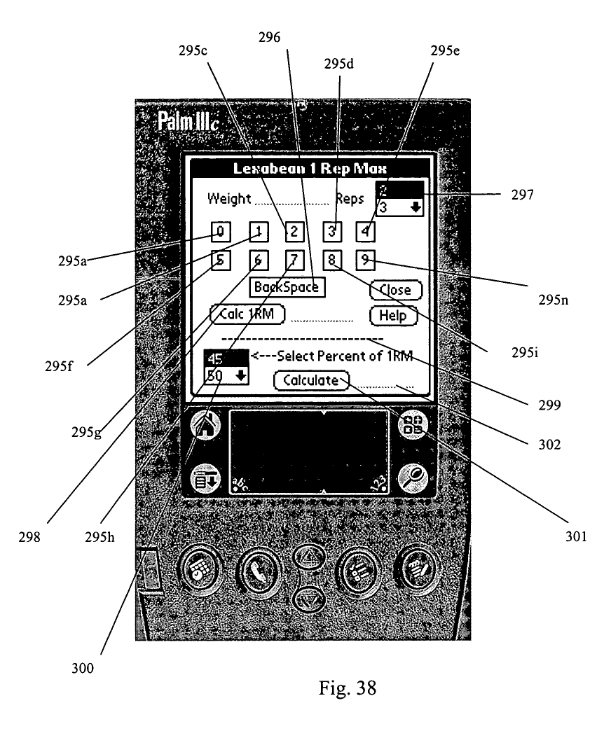

FIG. 2 and FIGS. 28-38 illustrate operation of strength training diary application 22 on handheld device 12. After strength training diary application 22 has been installed on handheld device 12, icon 20, such as labeled stdiary, will appear in an unfilled category of handheld device 12, such as personal digital assistant (PDA), as shown in FIG. 2. If icon 20 is tapped, strength training diary application 22 will open for displaying a form of a strength training diary on handheld device 12. Thereafter, a screen for strength training diary application 22 is displayed on handheld device 12. An example strength training diary application screen 200 is shown in FIG. 28.

Technique list can be displayed in area 201. Equipment list can be displayed in area 202. A notes section for tracking workouts saved in handheld device 12 can be displayed in notes area 203. A body position for selected technique and equipment can be displayed in area 204. An enter weight, sets and reps section can be displayed in area 205.

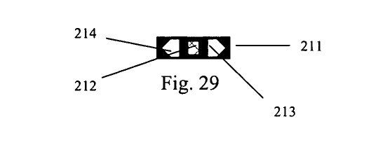

Video button 206 can be used to display video of selected techniques upon pressing video button 206. Video can be displayed, for example, upon interacting with a Kinoma video software. Icon 211 shown in FIG. 29 can be displayed upon interaction with software of the Kinoma viewer displayer. After playing the video, icon 211 can be activated to return to strength training diary application 22. For example, if a user clicks on square 212 of icon 211, the screen of handheld device 12 returns to strength training diary application screen 200. If a user clicks on arrow 213, the video will be forwarded. IF a user clicks on arrow 214, the video will be reversed.

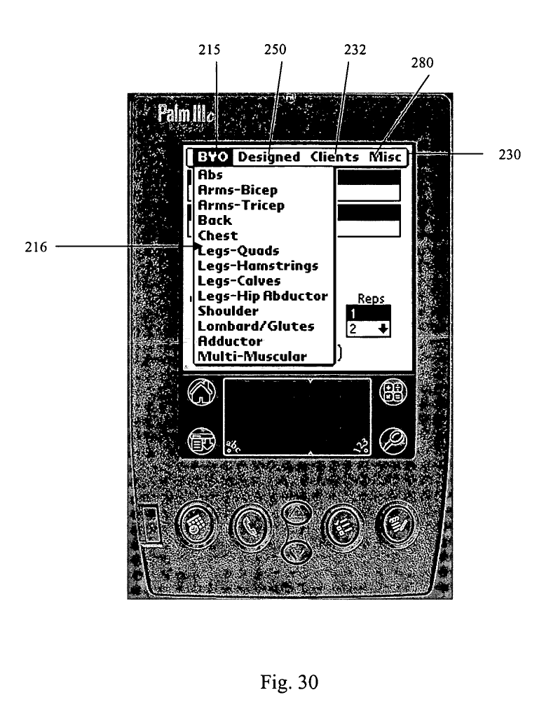

Referring to FIG. 28, menu icon 208 for accessing menu items is located at position 207. For moving within strength training diary application 22, features are accessed through menu items that appear on screen 200 which can be opened using menu icon 208. Alternatively, the top of screen 200 can be tapped at position 209 of the title bar for accessing features of strength training diary application 22, shown in FIG. 30.

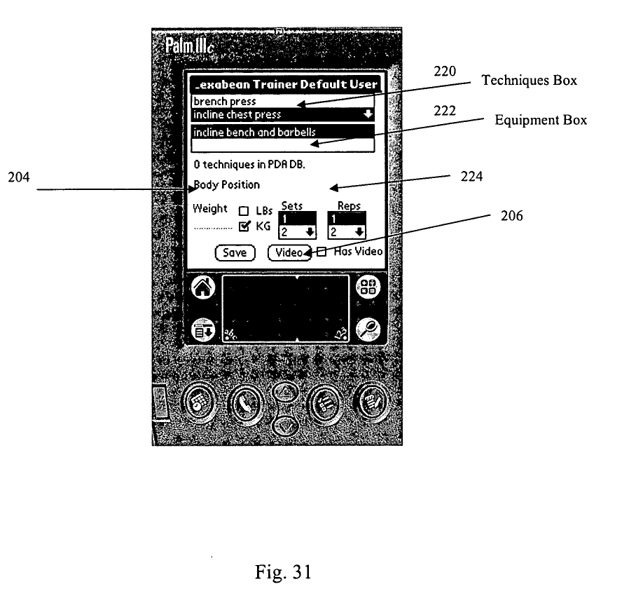

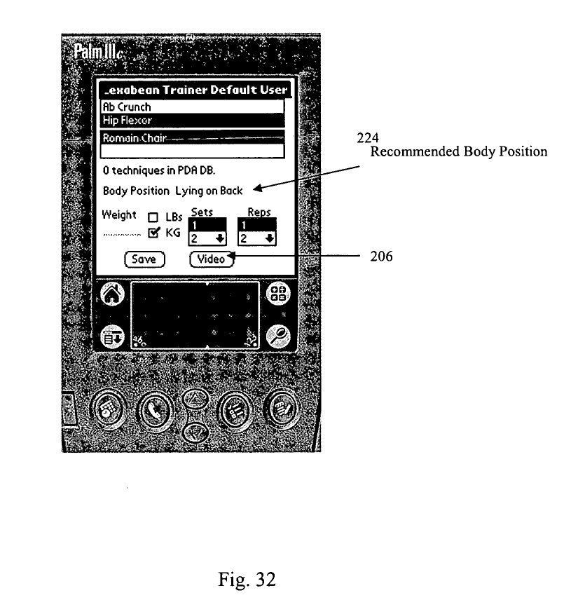

Body part (BYO) 215 of menu bar 230 can be used to open dropdown menu 216 listing of body parts with available techniques. Menu 216 enables the user to select body part specific techniques and view a video of the selected technique at handheld device 12. If a body part listed in menu 216 is tapped, a list of corresponding techniques is displayed in techniques box 220, as shown in FIG. 31. If a technique in techniques box 220 is tapped, a list of equipment is displayed in equipment box 222. If equipment in equipment box 222 is tapped, a recommended body position is displayed in recommended body position box 224 positioned at area 204, as shown in FIG. 32. Video button 206 can be tapped to display a video demonstrating proper form for the selected technique and equipment.

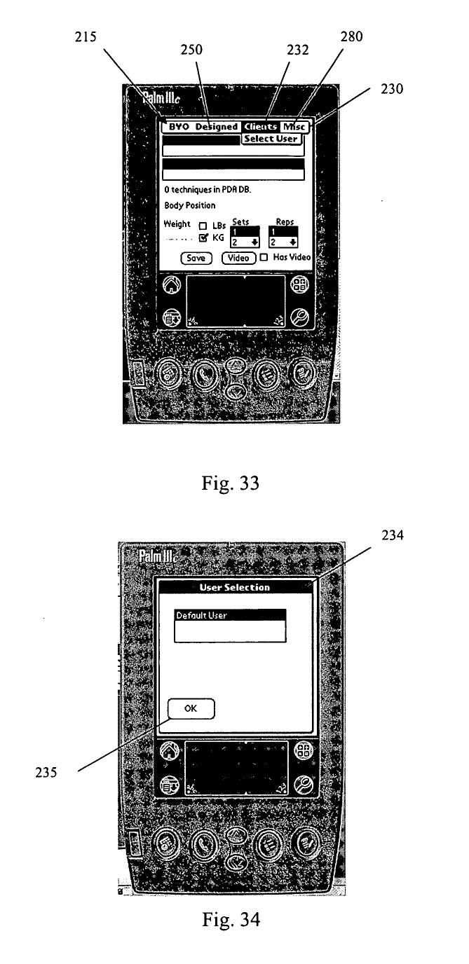

Referring to FIG. 28, when strength training diary application 22 opens, title bar 209 displays the user currently active in the diary as a user ID login. If the user is incorrect or includes Default User, then the correct user is selected before entering a workout into strength training diary application 22. Menu icon 208 or title bar 209 can be tapped to allow title bar 209 to change to menu bar 230 as shown in FIG. 33. Clients menu item 232 can be tapped to open user selecting screen 234 as shown in FIG. 34. A correct user login ID listed on user selection screen 234 can be tapped to select a user. Selection screen 234 can display only the registered user's login ID. Selection screen 234 for a personal trainer can include the login ID for the trainer and all registered clients. OK button 235 can be tapped and title bar 209 is updated to include the login ID of the user just selected.

Referring to FIG. 28, save button 240 can be used to save a workout at handheld device 12. User ID login is selected as described above. A desired technique and equipment is selected as described above. Weight (enter 0 if not applicable), sets and repetition data is entered at handheld device 12. For example, graffiti writing area 243 can be used to enter weight of a performed exercise. Save button 240 can be tapped to save the technique on handheld device 12. Notes area 203 can be updated to increase the number of techniques currently stored in handheld device 12.

Handheld device 12 can upload the saved workout to user processing system 14, website 17 for system 10 and/or personal trainer processing system 18. For example, if handheld device 12 is a PDA, the PDA can be HotSynced in a cradle to website 17. Workouts can be time stamped when the HotSync is performed. Accordingly, it is desirable that the PDA be HotSynced after every workout and at least once a day. Frequent HotSyncing ensures workouts will not be lost due to low battery levels.

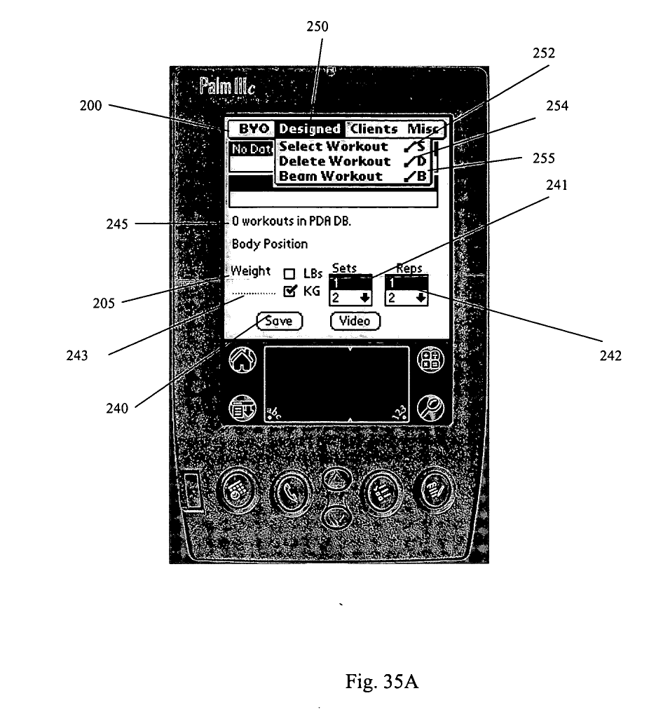

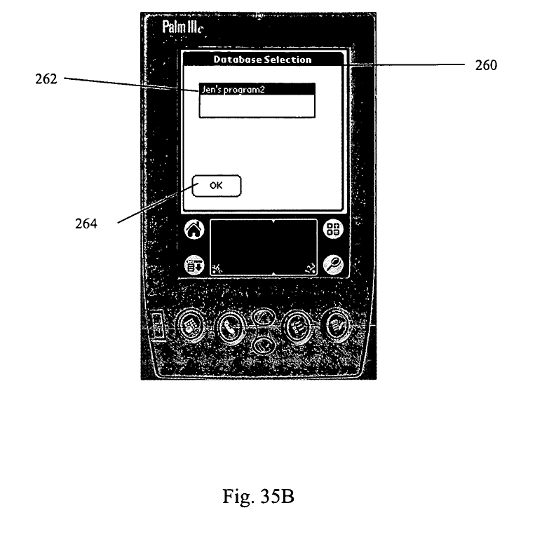

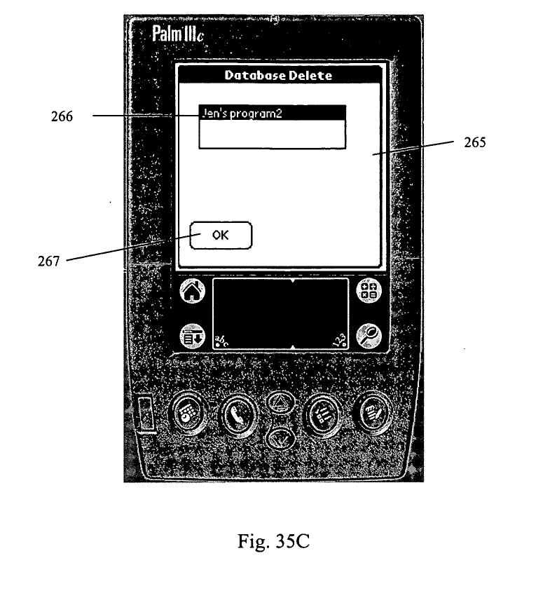

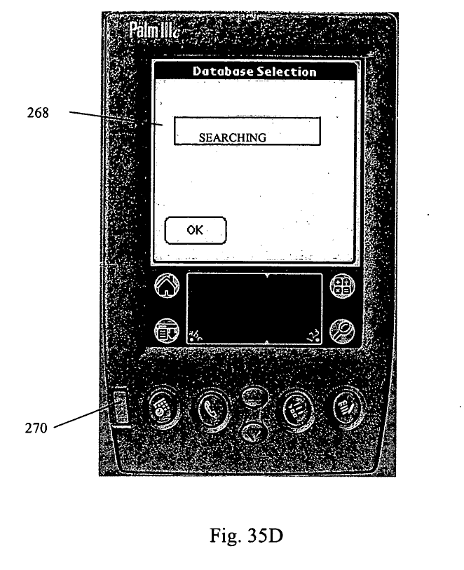

Referring to FIG. 33, designed entry 250 of menu bar 230 can be used to open custom created workouts to handheld device 12. For example, custom workouts can be opened by a trainer or coach and downloaded to handheld device 12. Designed entry 250 can be tapped to display select workout entry 252, delete workout entry 254 and beam workout entry 255, as shown in FIG. 35A. If select workout entry 252 is tapped, a database selection screen 260 opens listing all downloaded custom workouts, as shown in FIG. 35B. A name of file 262 for the custom workout can be tapped. Thereafter, OK button 264 can be tapped.

Strength training diary application screen 200 lists all the techniques selected for the custom workout. If a listed technique is tapped, the equipment box, body position, sets and reps fields will change to correspond to the custom workout as it was saved. To enter the workout as completed, the user ensures that the client's user ID login is correct, then the user enters data into area 243. A user can enter 0 in area 243 if it is not applicable. The user can enter the number of sets completed in set field 241. The user can enter the number of repetitions completed in repetitions field 242. Save button 240 can be tapped to save the technique on handheld device 12. Notes field 245 at area 203 is updated to increase by one the number of techniques currently stored in handheld device 12. The completed techniques can be uploaded to website 17 or user processing system 14 from handheld device 12, for example, by HotSyncing a PDA or whenever a PDA is HotSynced.

If delete workout entry 254 is tapped, database delete screen 265 opens listing all the downloaded custom workouts, as shown in FIG. 35C. The name of the file to delete 266 can be tapped and OK button 267 can be tapped to delete the workout.

If beam workout entry 255 is tapped, workouts can be beamed from one handheld device 12 to another handheld device 12a. For example, handheld device 12a can be used by a personal trainer or coach to beam workouts using handheld device 12 used by a client. Beam screen 268 will open, showing a status to first be “preparing” and then “searching”, as shown in FIG. 35D. Communication port 270 of a sending handheld device 12 or handheld device 12a can be pointed at a received user or handheld device 12a. Beam screen 268 will indicate that the transfer was successful. To open the workout on the receiving handheld device 12, designed entry 250 can be tapped as shown in FIG. 33. Select workout entry 252 can be tapped. Database selection screen 260 will now list the beamed workout. The name of the file 262 to open can be tapped and OK button 264 can be tapped to open the workout.

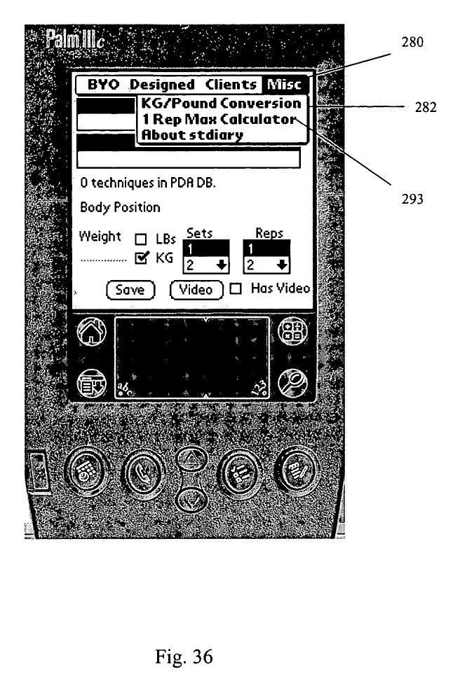

Referring to FIG. 33, miscellaneous entry 280 of menu bar 230 can be used to provide tools useful for designing custom workouts. Example tools can include a KG/pound conversion and a 1 rep max calculator. If miscellaneous entry 280 is tapped, tool menu 282 is displayed, as shown in FIG. 36.

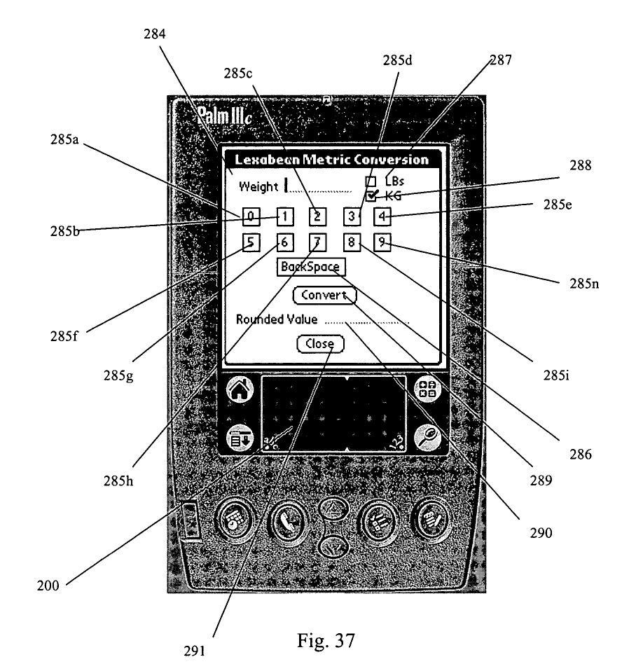

Menu item 282 can be used for accessing a kilogram/pound conversion calculator. If menu item 282 is tapped, conversion screen 284 can be displayed as shown in FIG. 37. A weight to be converted can be entered by tapping on respective numbered boxes 285a-285n. Backspace button 286 can be used to erase an incorrect entry. Pound (LB) weight box 287 can be tapped to identify that the entered units of weight is Lbs. Kilogram box 288 can be tapped to identify that the entered units of weight is KG. Convert button 289 can be tapped to perform the conversion and a converted number appears in rounded value field 290. Close button 291 can be tapped to return to strength training diary application screen 200.

Referring to FIG. 36, menu item 293 can be used for accessing a one rep max calculator. Training programs and personal trainers express the weight that the client should use for multiple reps as a percent of a calculated value of a one repetition maximum. Before performing the calculation, a weight is selected by a user that can be comfortably lifted for several repetitions. The weight to be used in the calculator is entered by tapping on respective numbered buttons 295a-295n. Backspace button 296 can be used to erase an incorrect entry. The number of repetitions completed can be entered in repetition box 297. Calc IRM button 299 can be tapped to calculate the one repetition maximum and the result will appear in field 299. Percent of IRM button 300 can be tapped to determine a desired percentage for a multiple-repetition workout using the entered values. Calculate button 301 can be tapped to determine the percent of 1 Rep Max. A determined value will appear in field 302.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

1. A system for providing a portable diary of fitness information comprising:
a handheld device, said handheld device including means for inputting data into said handheld device and means for displaying information on said handheld device;
remote processing means for generating said diary of fitness information, said diary of fitness information being in electronic form; and
communicating means for communicating between said handheld device and said remote processing means for receiving a form of said diary of fitness information from said remote processing device to be displayed on said handheld device and communicating said data inputted at said handheld device to said remote processing system.

2. The system of claim 1 wherein said diary of fitness information includes fitness information comprising one or more entries selected from one or more of workouts, food consumption, strength training, reports, body composition results, fitness results, triathlete information, race information, pace information, runner information, and coach information.

3. The system of claim 1 wherein said handheld device is a personal digital assistant.

4. The system of claim 1 wherein said handheld device can display one or more of video, animation or graphics associated with said form of said diary of fitness information.

5. The system of claim 4 wherein said one or more of video, animation or graphics display proper form for an exercise.

6. The system of claim 1 wherein said remote processing means comprises:
a personal computer directly or wirelessly connected to said handheld device.

7. The system of claim 1 wherein said remote processing means comprises a website for hosting an application for generating said diary of fitness information.

8. The system of claim 1 further comprising a personal trainer processing system, said personal trainer processing system communicating with said remote processing means for inputting said fitness information into said diary for fitness information.

9. The system of claim 8 further comprising:
a trainer handheld device, said trainer handheld device including means for inputting data into said trainer handheld device;
communicating means for communicating between said trainer handheld device and said trainer processing system for receiving said form of said diary of fitness information to be displayed on said trainer handheld device and communicating said data inputted at said trainer handheld device to said remote processing system.

10. The system of claim 9 further comprising:
means for beaming said form of said diary of fitness information from said trainer handheld device to said handheld device.

11. The system of claim 1 further comprising means for storing at said remote processing means said diary of fitness information and said data communicated from said handheld device.

12. The system of claim 1 wherein said remote processing means further comprises:
means for updating said diary of fitness information with said data received from said handheld device.

13. The system of claim 12 further comprising:
means for generating reports of said updated diary of fitness information.

14. The system of claim 13 wherein said means for generating reports generates reports in a predetermined date range.

15. The system of claim 14 wherein said diary of fitness information includes fitness test results and said means for generating reports generates reports of said fitness test results.

16. The system of claim 15 wherein said fitness test results comprise body composition test results.

17. The system of claim 16 wherein said remote processing means generates said body composition test results using an interface screen comprising positions for entering of a plurality of caliper measurements of body parts and further comprises means for determining an average value of said entered caliper measurements and means for displaying said average value on said interface screen.

18. The system of claim 17 wherein said interface further comprises positions for entering of sex information and age information and further comprising;
means for detecting a percentage of body from said entered caliper measurements, entered sex information and age information.

19. The system of claim 15 wherein said fitness test results comprise 3-minute step test results.

20. The system of claim 14 wherein said diary of fitness information includes runner information and said means for generating a report generates reports of runner workouts.

21. The system of claim 20 wherein said reports of said runner workouts lists said runner workouts for a predetermined date range.

22. The system of claim 20 wherein said reports of said runner workouts lists said runner workouts by distance.

23. The system of claim 1 wherein said diary of fitness information is a strength training diary.

24. The system of claim 23 wherein said form of said diary of fitness information displays:
a strength training workout of techniques and associated equipment on said handheld device; and
said means for inputting data into said handheld device inputs data on one or more of weight used on said associated equipment, a number of repetitions of said techniques and a number of sets of said number of repetitions.

25. The system of claim 23 further displays a body position for said technique on said handheld device.

26. The system of claim 1 wherein said diary of fitness information is a runners' diary.

27. The system of claim 26 wherein said diary of fitness information comprises an entry for downloading a pace calculator from said remote processing means to said handheld device.

28. The system of claim 1 wherein said diary of fitness information includes a customized workout wherein said remote processing means generates said custom workout using an interface screen, said interface screen including one or more entries of body parts, equipment, technique, body position, notes, video file, repetitions and sets.

29. The system of claim 1 wherein said form of said diary of fitness information displays a conversion screen at said handheld device for accessing a kilogram to pound conversion calculator.

30. The system of claim 1 wherein said form of said diary of fitness information displays a one repetition maximum screen at said handheld device for accessing a one repetition maximum calculator.

31. A system of providing a portable diary of fitness information comprising:
a handheld device, said handheld device including means for inputting data into said handheld device and means for displaying information in said handheld device said handheld device can display one or more of video, animation or graphics displaying proper form for an exercise;
remote processing means for generating said diary of fitness information, said diary of fitness information being in electronic form; and
communicating means for communicating between said handheld device and said remote processing means for receiving a form of said diary of fitness information to be displayed on said handheld device and communicating said data inputted at said handheld device to said remote processing system,
wherein said form of said diary of fitness information includes a display one or more of video, animation or graphics displaying proper form for an exercise.

32. A method for providing a portable diary of fitness information comprising the steps of:
generating said diary of fitness information at remote processing means, said diary of fitness information being in electronic form; and
communicating a form of said diary of fitness information to a handheld device;
displaying said form of said diary of fitness information on said handheld device,
inputting data into said handheld device; and
communicating said data inputted at said handheld device to said remote processing system.

33. The method of claim 32 wherein said diary of fitness information includes fitness information comprising one or more entries selected from one or more of workouts, food consumption, strength training, reports, body composition results, fitness results, triathlete information, race information, pace information, runner information, and coach information.

34. The method of claim 32 wherein said handheld device is a personal digital assistant.

35. The method of claim 32 further comprising the step of:
displaying on said handheld device one or more of video, animation or graphics associated with said form of said diary of fitness information.

36. The method of claim 35 wherein said one or more of video, animation or graphics display proper form for an exercise.

37. The method of claim 32 wherein said remote processing means comprises:
a personal computer directly or wirelessly connected to said handheld device.

38. The method of claim 32 wherein said remote processing means comprises a website for hosting an application for generating said diary of fitness information.

39. The method of claim 32 further comprising the steps of:
inputting said fitness information into said diary for fitness information at a personal trainer processing system; and
communicating said diary for fitness information to said remote processing means.

40. The method of claim 39 wherein said inputting step comprises:
inputting data into a trainer handheld device; and further comprises the step of communicating between said trainer handheld device and said trainer processing system for receiving said form of said diary of fitness information to be displayed on said trainer handheld device and communicating said data inputted at said trainer handheld device to said remote processing system.

41. The method of claim 40 further comprising the step of:
beaming said form of said diary of fitness information from said trainer handheld device to said handheld device.

42. The method of claim 32 further comprising the step of:
storing at said remote processing means said diary of fitness information and said data communicated from said handheld device.

43. The method of claim 32 further comprising the step of:
updating said diary of fitness information at said remote processing means with said data received from said handheld device.

44. The method of claim 43 further comprising the step of:
generating reports of said updated diary of fitness information.

45. The method of claim 44 wherein the step of generating reports generates reports in a predetermined date range.

46. The method of claim 45 wherein said diary of fitness information includes fitness test results and the step of generating reports generates reports of said fitness test results.

47. The method of claim 46 wherein said fitness test results comprise body composition test results.

48. The method of claim 47 further comprising the step of:
interacting with an interface screen to generate said body composition test results, said interface screen comprising positions for entering of a plurality of caliper measurements of body parts and further comprising the steps of determining an average value of said entered caliper measurements and displaying said average value on said interface screen.

49. The method of claim 48 wherein said interface further comprises positions for entering of sex information and age information and further comprising the step of:
detecting a percentage of body from said entered caliper measurements, entered sex information and age information.

50. The method of claim 46 wherein said fitness test results comprise 3-minute step test results.

51. The method of claim 44 wherein said diary of fitness information includes runner information and said step of generating a report generates reports of runner workouts.

52. The method of claim 51 wherein said reports of runner workouts lists said runner workouts for a predetermined date range.

53. The method of claim 51 wherein said reports of runner workouts lists said runner workouts by distance.

54. The method of claim 32 wherein said diary of fitness information is a strength training diary.

55. The method of claim 54 wherein said form of said diary of fitness information displays a strength training workout of techniques and associated equipment on said handheld device; and
said inputting step inputs data on one or more of weight used on said associated equipment, a number of repetitions of said techniques and a number of sets of said number of repetitions.

56. The method of claim 54 further comprising the step of:
displaying a body position for said technique on said handheld device.

57. The method of claim 32 wherein said diary of fitness information is a runners' diary.

58. The method of claim 57 wherein said diary of fitness information comprises an entry for downloading a pace calculator from said remote processing means to said handheld device and further comprising the step of using said pace calculator at said handheld device.

59. The method of claim 32 wherein said diary of fitness information includes a customized workout screen wherein said step of generating said diary of fitness information includes generating said custom workout using an interface screen, said interface screen including one or more entries of body parts, equipment, technique, body position, notes, video file, repetitions and sets.

60. The method of claim 32 wherein said form of said diary of fitness information displays a conversion screen at said handheld device and further comprising the step of accessing a kilogram to pound conversion calculator with said conversion screen.

61. The method of claim 32 wherein said form of said diary of fitness information displays a one repetition maximum screen at said handheld device and further comprising accessing a one repetition maximum calculator using said one repetition maximum screen.

62. A method of providing a portable diary of fitness information comprising the steps of:
generating said diary of fitness information at remote processing means, said diary of fitness information being in electronic form; and
communicating a form of said diary of fitness information to a handheld device;
displaying said form of said diary of fitness information on said handheld device, said handheld device can display one or more of video, animation or graphics displaying proper form for an exercise
inputting data into said handheld device; and
communicating said data inputted at said handheld device to said remote processing system,
wherein said form of said diary of fitness information includes display one or more of video, animation or graphics displaying proper form for an exercise.

63. A computer program product for providing a diary for fitness information comprising:
means for providing a visual representation of a diary for fitness information to a user at a handheld device;
means for entering feedback into said handheld device; and
means for receiving said feedback and updating said diary for fitness information.

64. The computer program product of claim 63 wherein said diary of fitness information includes fitness information comprising one or more entries selected from one or more of workouts, food consumption, strength training, reports, body composition results, fitness results, triathelete information, race information, pace information, runner information, and coach information.

65. The computer program product of claim 63 further comprising means for display one or more of video, animation or graphics associated with said form of said diary of fitness information.

66. The computer program product of claim 63 wherein said one or more of video, animation or graphics display proper form for an exercise.

67. The computer program product of claim 63 wherein said means for providing a visual representation comprises a means for interacting with a Web page for generating said diary for fitness information.

68. The computer program product of claim 63 further comprising:
means for generating reports of said updated diary of fitness information.

69. The computer program product of claim 68 wherein said means for generating reports generates reports in a predetermined date range.

70. The computer program product of claim 68 wherein said diary of fitness information includes fitness test results and said means for generating reports generates reports of said fitness test results.

71. The computer program product of claim 70 wherein said fitness test results comprise body composition test results.

72. The computer program product of claim 71 further comprising means for generating an interface screen comprising positions for entering a plurality of caliper measurements of body parts;
means for determining an average value of said entered caliper measurements;
and means for displaying said average value on said interface screen for generating said body composition results.

73. The computer program product of claim 72 wherein said interface further comprises positions for entering of sex information and age information and futher comprising; and
a means for detecting a percentage of body from said entered caliper measurements, entered sex information and age information.

74. The computer program product of claim 70 wherein said fitness test results comprise 3-minute step rest results.

75. The computer program product of claim 68 wherein said diary of fitness information includes runner information and said means for generating a report generates reports of runner workouts.

76. The computer program product of claim 75 wherein said reports of said runner workouts lists said runner workouts for a predetermined date range.

77. The computer program product of claim 75 wherein said reports of said runner workouts lists said runner workouts by distance.

78. The computer program product of claim 63 wherein said diary of fitness information is a strength training diary.

79. The computer program product of claim 78 wherein said form of said diary of fitness information displays:
a strength training workout of techniques and associated equipment on said handheld device; and
said means for entering feedback inputs data on one or more of weight used on said associated equipment, a number of repetitions of said techniques and a number of sets of said number of repetitions.

80. The computer program product of claim 23 further comprising means for displaying a body position for said technique.

81. The system of claim 1 wherein said diary of fitness information includes a customized workout, said custom workout including one or more entries of body parts, equipment, technique, body position, notes, video file, repetitions and sets.
